(19) United States
(12) Patent Application Publication
(10) Pub. No.: US 2026/0244435 A1
(43) Pub. Date: Aug. 20, 2026

(54) INCREASED PULL REQUEST CODE VISIBILITY AND DEPENDENCY ANALYSIS VIA CALL GRAPHS

(71) Applicant: Oracle International Corporation, Redwood Shores, CA (US)

(72) Inventors: Samuele Meta, Zurich (CH); Felix Schmidt, Zurich (CH)

(73) Assignee: Oracle International Corporation, Redwood Shores, CA (US)

(21) Appl. No.: 19/056,591

(22) Filed: Feb. 18, 2025

(51) Int. Cl. G06F 8/71; G06F 3/04842; G06F 8/41

(52) U.S. Cl. CPC G06F 8/71; G06F 3/04842; G06F 8/433

(57) ABSTRACT

Example systems and methods are described for improving Pull Request code visibility and code dependency analysis. One example method involves generating a first call graph representing a plurality of dependencies between sets of code in a plurality of sources, tracking changes made to a subset of a plurality of sets of code, generating a second call graph representing the subset of the plurality of sets of code, expanding the second call graph based on dependencies in the first call graph associated with at least one code set of the subset of the plurality of sets of code, and identifying one or more sets of code that are not in the subset of the plurality of sets of code based on the expanded call graph.

### BACKGROUND

A software development lifecycle refers to a structured process that outlines several stages involved in developing software, such as planning, requirement analysis, design, development, testing, deployment, maintenance, and so on. The various stages of a software development lifecycle are typically implemented systematically to facilitate high quality software development.

Software development teams work separately and together to produce libraries of code that work together to perform higher level software functionality. The libraries of code may be handled by different personnel with minimal knowledge of other libraries or other activities or goals of other software development teams. Despite this limited knowledge, code developed by the different software development teams often becomes part of or integrated with the same product or service that provides the higher level software functionality.

### BRIEF SUMMARY

In some embodiments, a computer-implemented method includes generating a first call graph representing a plurality of dependencies between sets of code in a plurality of sources. The method also includes tracking changes made to a subset of a plurality of sets of code. The method also includes generating a second call graph representing the subset of the plurality of sets of code. The method also includes expanding the second call graph based on dependencies in the first call graph associated with at least one set of code of the subset of the plurality of sets of code. The method also includes identifying one or more sets of code that are not in the subset of the plurality of sets of code based on the expanded call graph.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that analyzes pull request (PR) submissions by accounting for code dependencies.

FIG. 2 illustrates a system diagram showing an example PR code analysis system that analyzes PR submissions and relevant code dependencies.

FIG. 3 illustrates a diagram of an example user interface showing a PR code review and analysis that accounts for relevant code dependencies.

FIG. 4 illustrates a diagram of an example call graph extracted for a PR.

FIG. 5 illustrates a diagram of an example process for generating an enhanced call graph for a PR that considers direct code dependencies.

FIG. 6 illustrates a diagram of an example process for generating an enhanced call graph for a PR that considers direct and indirect code dependencies.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

Example systems and methods are described for improving Pull Request (PR) code visibility and code dependency analysis. An example PR code analysis system generates a call graph for a PR and expands the call graph to account for relevant code dependencies that may potentially be affected by the proposed code changes of the PR. In various embodiments, the example PR code analysis system that analyzes PR code changes while accounting for relevant code dependencies is implemented using non-transitory and/or transitory computer-readable storage media to store instructions which, when executed by one or more processors of a computer system, cause display of the user interface and processing of the received input to analyze PR code changes while accounting for relevant code dependencies. The example system for analyzing PR code changes while accounting for relevant code dependencies may be implemented on a local or cloud-based computer system that includes processors and a display for showing the user interface to a user for analyzing PR code changes while accounting for relevant code dependencies. The computer system may communicate with client computer systems for analyzing PR code changes while accounting for relevant code dependencies.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Software Development Lifecycle, Code Review, and Pull Requests

Code review is a systematic process which may be implemented during one or more stages of a software development life cycle (SDLC). During code review, one or more developers or collaborators may examine and/or evaluate code submitted by another developer or collaborator to identify potential issues, improve quality, ensure adherence to coding standards, provide feedback to enhance the overall codebase, etc. Code review processes may facilitate identifying bugs, improving readability, maintainability, and/or overall code quality of the code in a codebase.

For example, a Pull Request (PR) is an event that occurs during the SDLC where a developer or contributor proposes merging a set of code changes into a project codebase. Throughout the present disclosure, the terms “PR” and “code change set” may be used interchangeably. When a PR is submitted, other developers or collaborators may review or discuss the proposed set of changes before they are integrated into the codebase. For example, reviewing a PR may facilitate meeting software quality standards by preventing unfinished or incorrectly written code from being prematurely merged into a codebase (e.g., a stable main codebase, etc.).

Example PR review tools and systems are described herein. An example PR review tool is configured to display information about differences between proposed code and a codebase. For example, the PR tool may be configured to display a list of files affected by at least one code change. For each file, the example PR tool may highlight lines containing new or modified code (e.g., in green) and/or highlight lines containing old or deleted code (e.g., in red), for example.

### Code Dependency Analysis and Call Graph Extraction

Code dependency refers to the relationship between different components of a software system. For example, code dependencies may identify how changes in one part of the software system can affect other parts. Some software systems comprise multiple modules or components, which rely on one another to function properly. In the broad context of a codebase, code changes in one file may affect the functionality of code in other files in the codebase. Without a comprehensive understanding of code dependencies, software developers may unintentionally introduce bugs, create security vulnerabilities, and/or make mistakes that can harm the overall quality and/or reliability of a software system.

Code dependency analysis is a SDLC process used to examine and/or understand relationships and dependencies between various components, modules, or elements within a software system. Code dependency analysis is typically implemented as an independent process and/or during code compilation or debugging stages of the SDLC. For example, during compilation of a new codebase, a code dependency analysis tool can be used to identify or visualize code dependencies among all the various files and functions in the codebase, e.g., by analyzing the entire codebase. As another example, during a debugging process, a code dependency analysis tool can be used to visualize call dependencies between functions or subroutines associated with a particular execution instance of the codebase.

In some examples, a code dependency analysis tool may generate call graphs to visualize and/or analyze the relationships and dependencies between various components of a software program. A call graph is a graph representation (e.g., control-flow graph, etc.) or other data structure (e.g., a linked list, a tree, or tuples or other paired values) configured to represent calling relationships between various subroutines or functions in a computer program. For example, a call graph may be configured to represent each function (or subroutine) in a set of code as a node in the graph, and each function call (or subroutine call) in the set of code as a directed edge connecting two nodes.

In one example, a call graph extraction process may include identifying one or more function definitions and assigning a node in a call graph for each identified function definition. The process may also include identifying one or more function calls associated with each function definition. If a function call is detected, the process involves creating a directed edge (in the call graph) connecting the node corresponding to the function definition with a node corresponding to the function call. For example, if function A is called by function B, a directed edge is defined from the node corresponding to function B to the node corresponding to function A.

In another example, a call graph extraction process may include reading one or more source files associated with a codebase. The process also includes, for each source file, parsing code in the source file to identify one or more constructs (e.g., class definitions, function definitions, variable definitions, function calls, etc.). The process also includes creating a node in the call graph for each function definition. If a function call is identified inside a function definition, the process then includes creating a directed edge connecting the nodes of the function definitions associated with the function call. Thus, a call graph may be extracted automatically for one or more sets of code (or for an entire codebase) by analyzing the content of the associated source files.

In some scenarios, such as when there are a large number of source files containing code, the call graph extraction process may be automated. In one example, a dynamic extraction process involves generating a call graph associated with an execution instance of a program. For instance, an example system may generate a dynamic call graph that includes nodes and/or edges corresponding to specific functions and/or function calls activated during a particular execution instance or run of a computer program. In another example, a static extraction process involves generating a call graph based on an analysis of a particular set of source code (e.g., source code analysis). For example, a static call graph may be configured to consider or represent every possible execution instance or run of a particular software program, a codebase, or a one or more particular sets of code in a codebase.

### Extracting and Using Partial Call Graphs to Improve PR Code Visibility and Code Dependency Analysis

In some scenarios, code dependency issues may result from incremental or partial code changes such as those associated with PRs (e.g., after deployment of an initial version of a software system, etc.). For instance, a codebase may be complex and/or may include components that interact with one another in non-trivial ways and thus a proposed code change set or PR may have dependencies with some other unchanged code set that was not explicitly identified in the PR. However, traditional PR review tools (e.g., GitHub, GitLab, BitBucket, etc.) typically do not identify other files in a codebase that are not specifically changed in a PR. Thus, developers or collaborators using traditional PR tools may not necessarily have exposure or access to files and/or dependencies that are potentially affected (e.g., directly or indirectly) by code changes specified in a PR.

By way of example, consider a scenario where a codebase includes the following example files (e.g., sum.py, max.py, and fetch.py), which are presented below as including code in the Python programming language for the sake of example.

```
sum.py
def sum_data( ):
  data = fetch_data( )
  return sum(item[“value”] for item in data)
max.py
def max_data( ):
  data = fetch_data( )
  return max(item[“value”] for item in data)
fetch.py
def fetch_data( ):
  return [
    {“id”: 1, “value”: 10},
    {“id”: 2, “value”: 20}
  ]
```

In this example, the function fetch_data( ) in fetch.py may simulate reading of some data and the return of their values (e.g., ‘10’, ‘20’) in a list format. The function sum_data( ) in sum.py may call fetch_data( ) to get a list of data points and then perform a ‘sum’ operation over the values of these data points (e.g., compute a sum of the values). The function max_data( ) in max.py may call fetch_data( ) to get a list of data points and then perform a ‘max’ operation over the values of these data points (e.g., compute a maximum of the values).

Additionally, in this example, both of the functions sum_data( ) and max_data( ) have a dependency on fetch_data( ). Thus, a modification of fetch_data( ) could potentially result in a change in the logic (or a failure) of sum_data( ) and/or max_data( ), unless the code of those functions is modified accordingly (if necessary) to account for the modification of fetch_data( ).

For instance, consider a scenario where a developer working on a PR proposes an update to fetch_data( ). In this scenario, the developer remembers to update max_data( ) accordingly but does not remember to update sum_data( ) accordingly, as depicted in the example code snippets below.

```
sum.py (not updated)
def sum_data( ):
  data = fetch_data( )
  return sum(item[“value”] for item in data)
max.py (updated)
def max_data( ):
  data = fetch_data( )[“data”]
  return max(item[“value”] for item in data)
fetch.py (updated)
def fetch_data( ):
  return {
    “data” : [
      {“id”: 1, “value”: 10},
      {“id”: 2, “value”: 20}
    ],
    “metadata”: {
      “timestamp”: 1729851201,
      “source”: “sensor”
    }
  }
```

In this example, the updated function fetch_data( ) in fetch.py still simulates the reading of some data and the return of their values. However, the data format of the returned data has changed after adding ‘metadata’. The updated function max_data( ) in max.py still calls fetch_data( ) to get the data points and still computes a maximum of their values correctly. In particular, the fetching step in the function max_data( ) was also changed to deal with the new data format of the function fetch_data( ). Thus, the updated function max_data( ) may work correctly in this example. On the other hand, the function sum_data( ) in sum.py still calls fetch_data( ) to get the data points as well but may not be able to compute a sum of their values correctly. In particular, since the fetching step in the function sum_data( ) was not updated, the function sum_data( ) may receive data points from the function fetch_data( ) in a new unsupported format (or with incorrect values).

Traditional PR review tools may not necessarily identify or mitigate such risk. For instance, in the example scenario above, a PR review tool may compare code (e.g., via a text comparison) in the PR and the codebase to provide feedback indicating that files max.py and fetch.py were affected by changes, a return statement in fetch.py was changed, and/or a definition of variable data in max.py was changed. However, a traditional PR review tool may not necessarily indicate that the proposed PR changes could also potentially affect the file sum.py because there were no actual changes to the code of sum.py indicated in the PR.

Accordingly, the present disclosure includes example systems and methods that enhance the PR review process by increasing PR code visibility and code dependency identification via generation and extraction of customizable Call Graphs. Thus, in some aspects, example systems described herein improve detection of potential bugs and issues associated with code dependencies during PR code review.

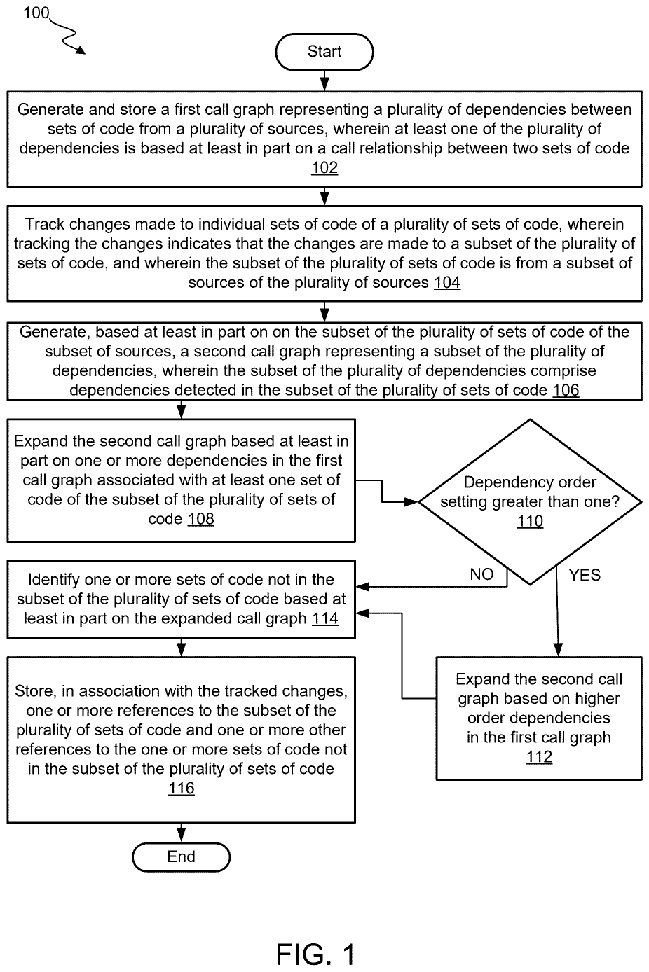

FIG. 1 illustrates a flow chart of an example process 100 that analyzes PR submissions by accounting for code dependencies. The process 100 begins at 102 where an example PR code analysis system generates and stores a first call graph representing a plurality of dependencies (e.g., function calls, subroutine calls, etc.) between sets of code (e.g., functions, subroutines, etc.) from a plurality of sources (e.g., source code files). At least one of the plurality of dependencies may be based at least in part on a call relationship between at least two sets of code. For example, the PR code analysis system may generate the first call graph as a global or comprehensive or codebase call graph based on an analysis for multiple source code files associated with a codebase.

In some examples, the process 100 includes the example PR code analysis system parsing, for each source of the plurality of sources, code content of the source to identify one or more respective sets of code corresponding to a class definition, a function definition, a variable definition, or a function call. In these examples, the example PR code analysis system may generate the first call graph at 102 by adding, in the first call graph, a node for each identified set of code corresponding to the class definition, the function definition, the variable definition, or the function call. Furthermore, in these examples, the example PR code analysis system may add, in the first call graph, a directed edge for each identified function call, wherein the directed edge is from a first node that represents the function call to a second node that represents a function definition associated with the function call.

At 104, the example PR code analysis system tracks changes made to individual sets of code of a plurality of sets of code. Tracking the changes at 104 may indicate the changes are made to a subset of the plurality of sets of code, where the subset of the plurality of sets of code is from a subset of sources of the plurality of sources. For example, the PR code analysis system may identify a first set of code in a first source code file (e.g., function A in file1.py) and a second set of code in a second source code file (e.g., function B in file2.py) as the individual sets of code in a codebase that includes multiple source code files (e.g., file1.py, file2.py, file3.py, etc.) storing multiple functions or subroutines (i.e., the plurality of sets of code) that together form the codebase.

At 106, the example PR code analysis system generates, based at least in part on the subset of the plurality of sets of code, a second call graph representing a subset of the plurality of dependencies. The subset of the plurality of dependencies may comprise dependencies detected in the subset of the plurality of sets of code.

At 108, the example PR code analysis system expands the second call graph based at least in part on one or more dependencies in the first call graph. The one or more dependencies are associated with at least one set of code of the subset of the plurality of sets of code. The one or more dependencies may include at least one dependency that was not detected in the subset of the plurality of sets of code. The at least one dependency may involve a particular set of code from a particular source not in the subset of sources.

By way of example, the PR code analysis system may generate a PR or local or partial call graph as the second call graph that includes first nodes corresponding to functions, sets of code, etc., that were updated or changed in the PR. The PR code analysis system may also include, in the second call graph, second nodes identified from the first call graph. The second nodes, for instance, may correspond to other functions or subroutines that were not explicitly updated or changed in the PR but that are either called by one or more functions or subroutines of the first nodes, or call one or more functions or subroutines of the first nodes. To facilitate this, for example, the PR code analysis system may identify a subset of the plurality of dependencies of the first call graph (e.g., represented as edges in the first call graph) between the first nodes (e.g., corresponding to updated functions or code changes indicated explicitly in the PR) and the second nodes (e.g., functions represented in the first call graph that have dependencies with the first nodes but are not explicitly updated in the PR).

In some examples, generating the second call graph at 106 includes the example PR code analysis system adding a node in the second call graph for each set of code in the subset of the plurality of sets of code. For example, the system may add a graph node for each set of code that has a code change in the PR. In these examples, generating the second call graph at 106 may also include the example PR code analysis system adding an edge in the second call graph between each pair of nodes in the second call graph that correspond to a pair of sets of code having a dependency. For example, the system may identify each set of code that was updated and that includes a function call and then add an edge in the second call graph between the node of the identified set of code and another node representing the function definition of the function call.

In some examples, the tracking the changes at 104 and the generating the second call graph at 106 are performed in parallel (e.g., and/or concurrently). For example, the PR code analysis system may update the second call graph and/or its code analysis every time a software developer enters a change to the code so that the software developer may receive information about potential code dependency issues (and/or other code issues) in real-time while updating any set of code in the codebase.

At 110, the example PR code analysis systems determines whether a dependency order configuration setting is set to a value greater than one. For example, a user of the example PR code analysis system may instruct the system to consider second or third or any other higher order dependencies by selecting a dependency order setting of two, three, four, etc. If so, the process 100 proceeds at 112. Otherwise, the process 1090 proceeds at 114.

At 112, the example PR code analysis system expands the second call graph based on higher order dependencies from the first call graph. For example, if function A is initially included in second call graph at 106 (e.g., due to having a code change indicated in the PR) has a dependency with function B, function B may be added to the second call graph at 108 as a first order dependency. Furthermore, if function B has a dependency with function C (e.g., even if function C does not have a direct dependency with function A), then function C may be added to the second call graph at 112 (e.g., as a second order dependency) based on the dependency order setting being two or higher. In other words, the example PR code analysis system may adaptively adjust a depth of its dependency analysis for the PR depending on the dependency order setting.

In some examples, the process 100 may also include the example PR code analysis system accessing, in a user session, user input including the dependency order setting indicative of a requested code dependency analysis depth, where expanding the second call graph (e.g., at 112) traverses the first call graph a number of steps away from the subset of the plurality of sets of code based at least in part on the dependency order setting.

In some examples, the process 100 may also include the example PR code analysis system expanding the second call graph to indicate second order dependencies of the subset of the plurality of sets of code based on the dependency order setting having a value greater than one. For example, the system may expand the second call graph at 112 to include second order dependencies if a user-provided configuration or other configuration of the dependency order setting has a value of two, three, four, or any value higher than one.

In some examples, the process 100 may also include the example PR code analysis system expanding the second call graph to indicate third order dependencies of the subset of the plurality of sets of code based on the dependency order setting having a value greater than one. For example, the system may expand the second call graph at 112 to include third order dependencies (e.g., dependencies in the sets of code of the second order dependencies) if a user-provided configuration or other configuration of the dependency order setting has a value of three, four, or any value higher than one.

In some examples, the process 100 may also include the example PR code analysis system excluding, from the expanded call graph, dependencies of the one or more sets of code not in the subset of the plurality of sets of code based on the dependency order setting having a value of one. For example, if the dependency order setting is one, then the example PR code analysis system may exclude second or higher order dependencies from the expanded second call graph (e.g., to reduce the total number of potential dependency issues identified for further review).

At 114, the example PR code analysis system identifies one or more sets of code not in the subset of the plurality of sets of code based at least in part on the expanded call graph, in line with the discussion above. At 116, the example PR code analysis system stores, in association with the tracked changes, one or more references to the subset of the plurality of sets of code and one or more other references to the one or more sets of code not in the subset of the plurality of sets of code. The one or more sets of code may include the particular set of code that is from a particular source not in the subset of sources.

By way of example, the PR code analysis system may store metadata or other reference data identifying one or more functions or subroutines that were explicitly updated in the PR (e.g., the subset of the plurality of sets of code) as well as one or more functions or subroutines that were not explicitly updated in the PR (e.g., the one or more other sets of code) but that may be potentially affected by the PR due to having a direct or indirect dependency with the subset of the plurality of sets of code that was changed in the PR.

In some examples, the process 100 may also include the example PR code analysis system expanding the second call graph further based on one or more other dependencies in the first call graph. The one or more other dependencies are associated with one or more other sets of code that are not in the subset of the plurality of sets of code and that are different than the one or more sets of code comprising the particular set of code. For example, expanding the call graph at 108 may include second or higher order code dependencies of the one or more sets of code identified at 114.

In some examples, the process 100 may also include the example PR code analysis system causing display, by a user interface, of information about the tracked changes based at least in part on the one or more references and the one or more other references. For example, the PR code analysis system may display annotated excerpts from the code base (e.g., corresponding to the one or more references and the one or more other references) such as highlighted lines of code that were added or deleted, highlighted lines of code that include dependencies (e.g., function calls to or from an updated set of code), and/or a graphical representation of a local call graph to facilitate visualizing relevant code dependencies and/or other potential code issues.

In some examples, causing display of the information comprises causing display of a graphical element that is selectable to analyze a particular set of code that is accessible via a particular reference of the one or more other references. By way of example, the PR code analysis system may render a visual representation of the expanded call graph that includes nodes (e.g., as graphic objects like circles) representing sets of code that are changed or that have dependencies from or to a changed set of code as well as edges/directed edges that represent dependencies between sets of code represented by the connected nodes. In this example, a user may click or select on a node or edge to cause the system to update its display of information about the various sets of code (e.g., by scrolling a code review pane to a location of a particular set of code or a particular code dependency, etc.).

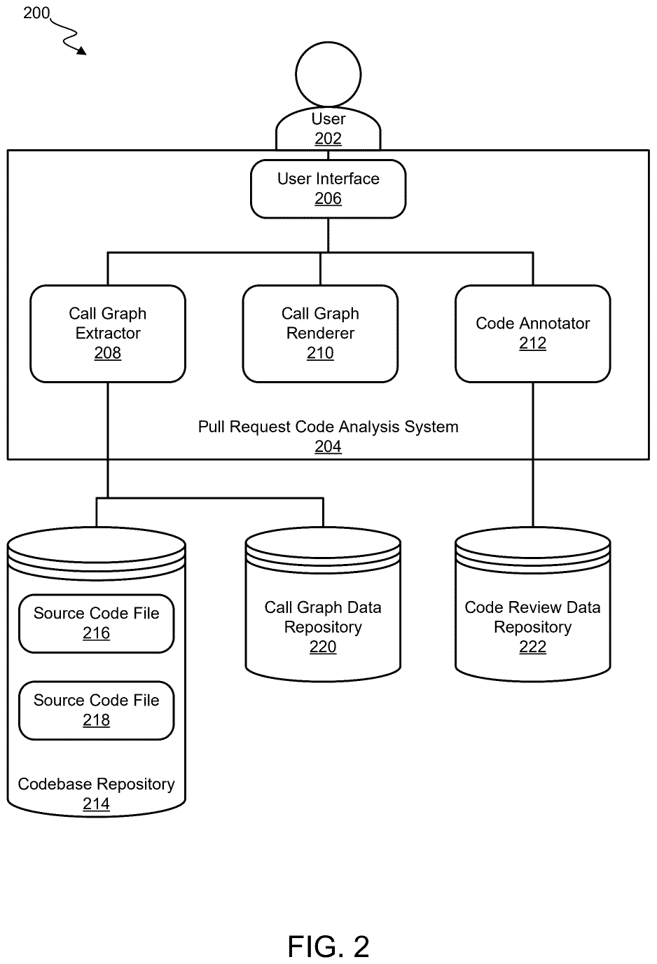

FIG. 2 illustrates a system diagram 200 showing an example PR code analysis system 204 that analyzes PR submissions and relevant code dependencies. In the illustrated example, the PR code analysis system 204 includes a user interface 206, a call graph extractor 208, a call graph renderer 210, and a code annotator 212. For example, a user 202 may interact with the PR code analysis system 204 via the user interface 206.

The user interface 206 may include a graphical user interface (GUI) or any other user interface configured to receive inputs from the user 202, such as PRs, PR selections, configuration settings (e.g., dependency order settings, etc.), and/or any other inputs (e.g., call graph rendering settings, source code file selections, etc.) relevant to the functionality of the various processes (e.g., process 100) described herein. The user interface 206 may also be configured to provide outputs to the user 202, such as a display of output information about a PR code review and/or analysis (e.g., call graph rendering, annotated code excerpts or highlighted lines of code, etc.) or any other indication of code changes and/or code dependencies associated with code changes of a pull request.

The call graph extractor 208 includes any combination of software and/or hardware components configured to extract, process, and/or store call graph information in the codebase repository 214 and/or the call graph data repository 220. In examples, the call graph extractor 208 is configured to provide information about an extracted call graph to the user 202 via the user interface 206. For example, the call graph extractor 208 may generate a partial call graph that includes nodes corresponding to one or more functions explicitly updated or changed in a particular PR, nodes corresponding to one or more functions not explicitly updated in the particular PR but having dependencies with the one or more updated functions, and edges representing code dependencies between the various nodes included in the extracted call graphs. As another example, the call graph extractor 208 may generate, store, and/or retrieve information about an extracted call graph from the call graph data repositor 220 (e.g., a comprehensive call graph for an entire codebase, etc.).

The call graph renderer 210 includes any combination of software and/or hardware components configured to render a call graph for display to the user 202 via the user interface 210. For example, the call graph render 210 may be configured to display a graphical representation of a partial call graph that includes nodes corresponding to functions or subroutines affected by changes in a PR. In some examples, call graph renderer 210 may be configured to dynamically update the displayed call graph at the user interface 206 to selectively include or exclude first order dependencies, second order dependencies, etc., and/or one or more specific nodes depending on user inputs received from the user 202 via the user interface 206.

The code annotator 212 includes any combination of software and/or hardware components configured to annotate, format, or otherwise condition one or more sets of code (or portions thereof) for display to the user 202 via the user interface 206. For example, the code annotator 212 may highlight (e.g., via colors, etc.) code additions, code deletions, and/or code dependencies associated with a PR request in an efficient manner to notify the user 202 about various code changes and/or code dependencies associated with a PR. In some examples, the code annotator 212 may determine and/or store (e.g., in code review data repository 222) one or more references to one or more sets of code associated with a PR (e.g., code changes, code dependencies, etc.) by analyzing the PR indicated by the user 202 via the user interface 206.

The codebase repository 214 and the call graph data repository 220 may include any combination of data storage elements such as databases, file servers, etc., configured to store information about call graphs. For example, the codebase repository 214 may include a plurality of sources (e.g., source code file 216, source code file 218, etc.) associated with a project codebase. Each source, for example, may include lines of code corresponding to a respective subset of a plurality of sets of code that together form the codebase. The code review data repository 222 may include any combination of data storage elements configured to store code review data (e.g., references to one or more sets of code associated with code changes in a PR, etc.).

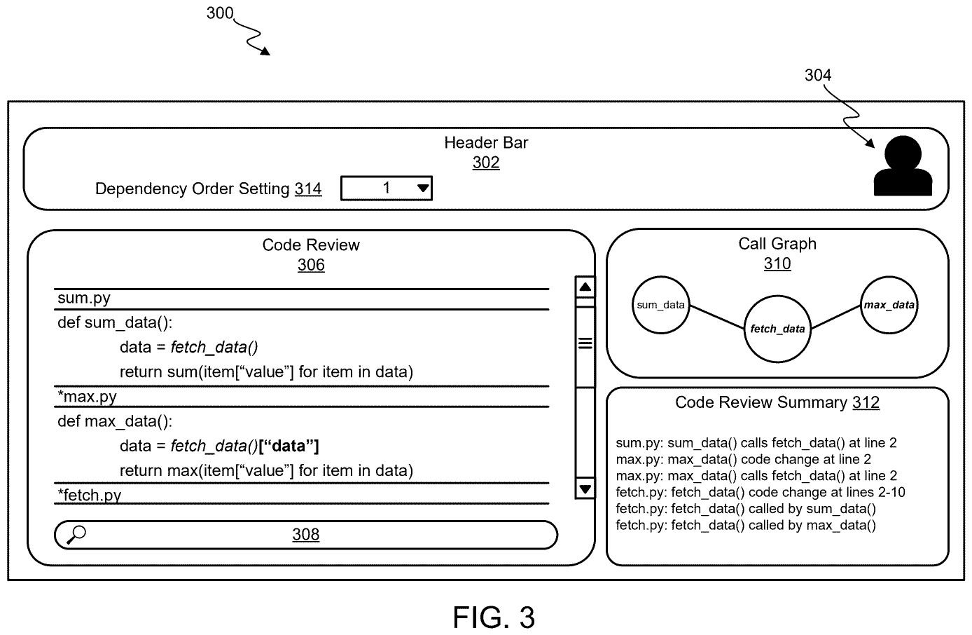

FIG. 3 illustrates a diagram of an example user interface 300 showing a PR code review and analysis that accounts for relevant code dependencies. In the illustrated example, the user interface 300 includes a plurality of graphical user interface (GUI) elements such as header bar 302, user account indicator 304, code review element 306, input element 308, call graph 310, code review summary 312, and dependency order configuration setting 314. The user interface 300 may be similar to the user interface 206.

The header bar 302 is a GUI element configured to present information about a user session of a user that is accessing the user interface 300. For example, the header bar 302 includes the user account indicator 304, which may include a graphic indicator of a user account (e.g., profile image, text, etc.) or other identifier of the user accessing the user interface 300. The header bar 302 may also include one or more input elements used to configure call graph extraction, filter, and/or tune information presented in the other GUI elements of the user interface 300. For example, the dependency order setting 314 may include an input element (e.g., dropdown box, input text box, etc.) configured to receive user input for adjusting the dependency order setting configuration of the example PR code analysis system 204 (e.g., the dependency order setting described at block 110 of the process 100).

The code review pane 306 includes any GUI element configured to display or provide output indicating the code review results of the example PR code analysis system 204. For example, the code review pane 306 may display annotated code snippets or experts that highlight code changes, such as by using italics or other code color scheme to highlight code dependencies (e.g., ‘fetch_data( )’), using bold text format or other code coloring scheme to highlight code additions (e.g., ‘[“data”]’), and so on, in a particular line or portion of the displayed code.

The input element 308 may include any combination of GUI elements that a user of the user interface 300 can use to provide input such as a PR (e.g., set of code changes), a PR identifier (e.g., ID of a PR submitted by another user), and so on. For example, the PR code analysis system 204 may populate the code review pane 306, call graph 310, and/or code review summary pane 312 in response to or based on input received via the input element 308.

The call graph 310 includes any GUI element configured to display a graphical representation of a call graph extracted based on the PR submitted or indicated by the user via the input element 308. For example, the call graph 310 may include circle graphics representing nodes in the expanded call graph described at block 108 of the process 100, and line segments connecting the nodes to represent code dependencies between the connected nodes, as depicted in the illustrated examples. In some examples, the call graph 310 may include an indicator of nodes that have code changes in the PR. For example, the nodes labeled ‘fetch_data’ and ‘max_data’ are depicted using a bold and italic text format to indicate that the PR indicates code changes in the sets of code represented by these nodes, whereas the node labeled ‘sum_data’ does not have an italic or bold text format to indicate that there were no code changes in the PR corresponding to the set of code of this node.

The code review summary pane 312 includes any GUI element configured to display a summary of code review items detected based on the code analysis conducted by the PR code analysis system 204. For example, the code review summary pane 312 may list information such as one or more references to one or more sets of code potentially affected by the PR, the name of a source code file (e.g., sum.py, max.py, fetch.py, etc.) affected by the PR, line number(s) associated with a potential code issue (e.g., ‘line 2’, ‘lines 2-10’, etc.), a description of the potential code issue (e.g., ‘sum_data( ) calls fetch_data( )’, ‘max_data( ) code change detected’, etc.).

In some examples, the user interface 300 is configured to update the content of code review pane 306 in response to selection input received via the call graph 310 and/or the code review summary pane 312. For example, if a user selects a node or edge in the call graph 310, the user interface 300 may update the code review pane 306 by scrolling to or highlighting specific code lines associated with the selected node or edge. As another example, if a user selects a certain item in the code review summary pane 312, then the user interface 300 may update the code review pane 306 to scroll to and/or highlight the specific line(s) of code referenced by the selected item.

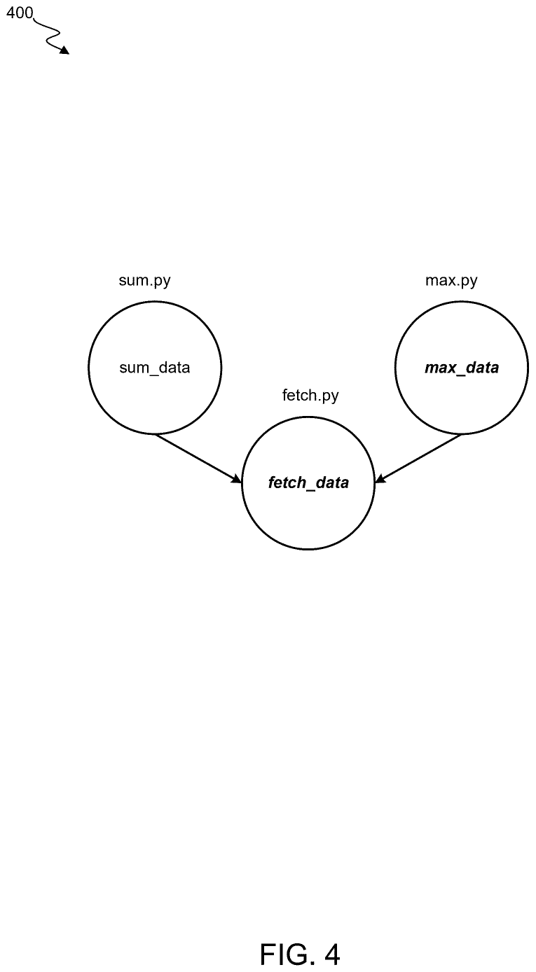

FIG. 4 illustrates a diagram of an example call graph 400 extracted for a PR. In the illustrated example, the call graph 400 includes the function definitions represented as nodes (e.g., ‘max_data( )’, ‘sum_data( )’, and ‘fetch_data( )’). Further, the call graph 310 includes edges (e.g., depicted as arrows) connecting the nodes associated with ‘max_data( )’, ‘sum_data( )’, and ‘fetch_data( )’, e.g., because the functions ‘sum_data( )’ and ‘max_data( )’ include function calls to the function ‘fetch_data( )’. In an example, the call graph 400 may be an expanded version of the call graph 310 which may be displayed, e.g., in response to a user input or other user configuration setting received via the user interface 300. In the illustrated example, the call graph 400 may be rendered to display additional information about the expanded call graph (e.g., block 108 of method 100), such as by including text labels adjacent to each node to identify a source code file associated with each node (e.g., ‘sum.py’, ‘fetch.py’, max.py’) and/or by displaying graphical indicators (e.g., arrows) to indicate properties of code dependencies. For instance, in the illustrated example, the direction of the arrow between the nodes labeled ‘sum_data’ and ‘fetch_data’ may visually indicate that the function ‘sum_data( )’ includes a function call to the function ‘fetch_data( )’.

### Customizable Call Graph Extraction and Configuration to Integrate Code Dependency Analysis in PR Code Review

In some aspects, an example system described herein may perform customizable call graph extraction and configuration to integrate code dependency analysis in PR code review. Thus, the example system may increase code visibility and/or selectively extract relevant code dependencies by building and/or combining a call graph of a codebase with a call graph (e.g., partial call graph) of a PR to suggest a list of dependencies for review. In some aspects, a call graph may be build from source code analysis that does not necessarily require compilation, thereby supporting analysis of partial code and/or non-compilable code. In some aspects, an example call graph extraction process herein may be agnostic to any specific programming language. In some aspects, dependencies of a customizable order (e.g., first order dependencies, second order dependencies, etc.) can be extracted depending on user preferences (e.g., dependency order setting 314).

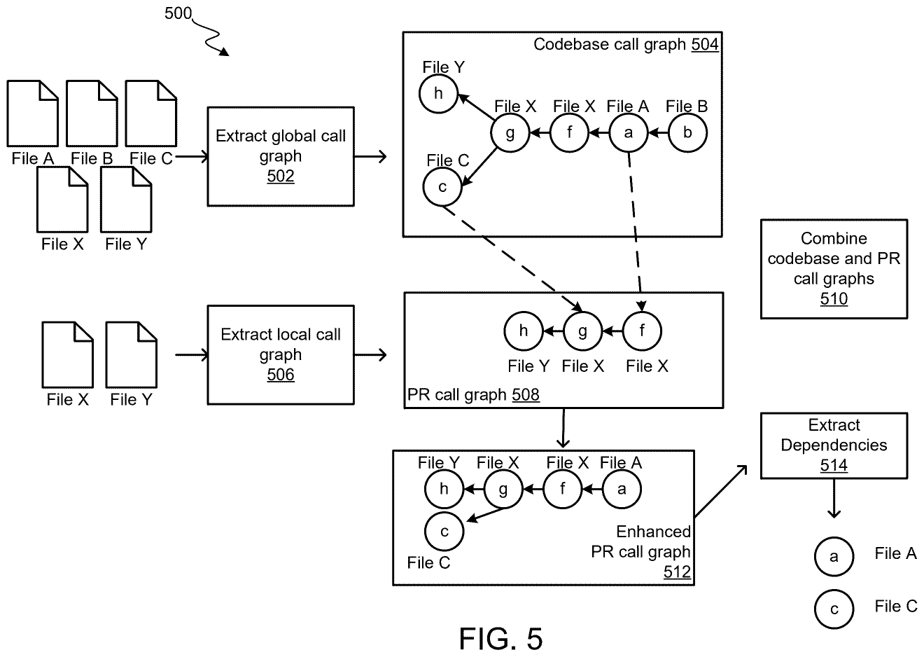

FIG. 5 illustrates a diagram of an example process 500 for generating an enhanced call graph for a PR that considers direct code dependencies. At 502, the process 500 involves an example PR code analysis system analyzes a code base that includes five source code files (e.g., File A, File B, File C, File X, and File Y) to generate a global or codebase call graph 504. The codebase call graph 504 includes information about all the function calls in the codebase (e.g., functions b, a, f, g, c, and h). For example, as shown, the call graph 504 indicates that function b in file B calls function a in file A.

In the example scenario of FIG. 5, a user submits a PR that includes changes to functions g and f of File X and function h of File Y. Thus, at 506, the example PR code analysis system processes the updated file X and file Y to generate local or PR call graph 508 accordingly. The call graph 508 may include information about function calls in file X and file Y. For example, as shown, call graph 508 indicates that function g in file X calls function h in file Y.

In some examples, the example PR code analysis system may perform the functions of block 502 and 506 independently and/or in parallel. At 510, the example PR code analysis system combines information from call graphs 504 and 508 to generate the enhanced PR call graph 512. For example, for each node in the PR call graph 508, the system may query the codebase call graph 504 to identify or retrieve information about incoming and/or outgoing dependencies. The example system may then use the retrieved information to generate the enhanced PR call graph 512 which incorporates information about function calls across files X and Y as well as function calls associated with dependencies in other files. For example, as shown, the enhanced PR call graph 512 indicates that function g in file X calls function c in file C and that function f in file X is called by function a in file A.

At 514, the example PR code analysis system extracts information about dependencies (e.g., first order dependencies, etc.) indicated in the enhanced PR call graph 512 (e.g., function a of File A and function c of File C), which may be affected by code changes in the PR even if the code of those particular functions was not necessarily modified in the PR. The example system may then provide output about these dependencies (e.g., via user interface 300, etc.) to notify a user (e.g., code reviewer) about the potential code dependency issues associated with files A and C and thus increase code visibility during the PR code review process.

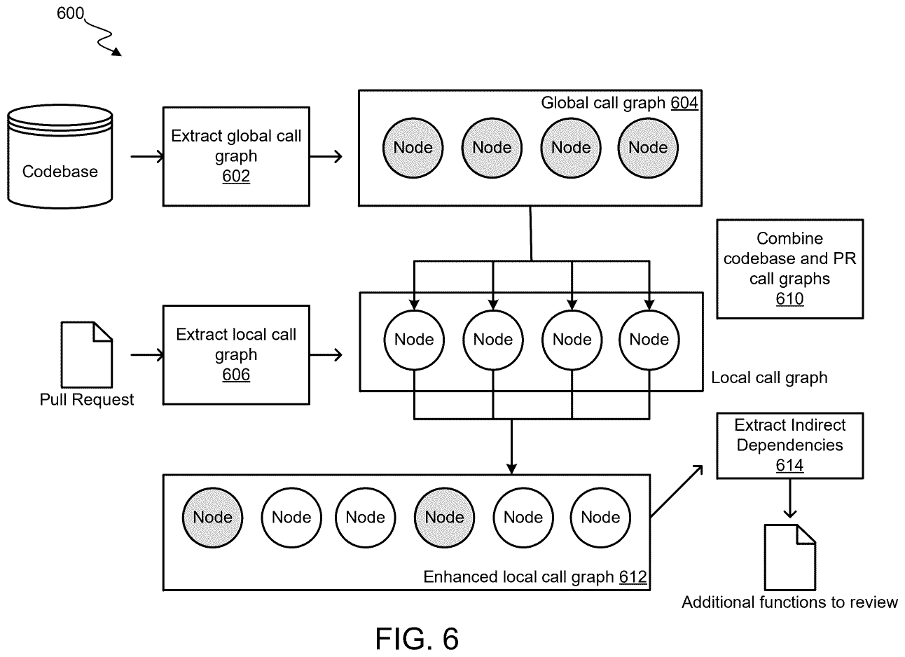

FIG. 6 illustrates a diagram of an example process 600 for generating an enhanced call graph for a PR that considers direct and indirect code dependencies. At 602, the process 600 involves an example PR code analysis system processing a codebase to extract a codebase or global call graph 604. The process of 602 may be applied to any codebase, any programming language, and/or any number of files of any length. At 606, the example PR code analysis system extracts a local call graph for an input PR, which may include any PR, any programming language, and/or any number of files having any length. At 610, the example system process the outputs of 602 and 606 (e.g., the global call graph and the local call graph, etc.) to generate the enhanced local call graph 612, which may include nodes from the global call graph 604 and the local call graph as depicted in the illustrated example. At 614, the example system processes the enhanced local call graph 612 to extract dependencies, which may include first order dependencies and/or higher order dependencies. For example, in scenarios where a code reviewer is interested in reviewing dependencies of dependencies (i.e., higher order dependencies), the example system can be configured to incorporate (e.g., in the enhanced call graph 612) information about the higher order dependencies (e.g., indirect dependencies) that the example system at 614 outputs the additional functions to review including such higher order dependencies.

### Computer System Architecture

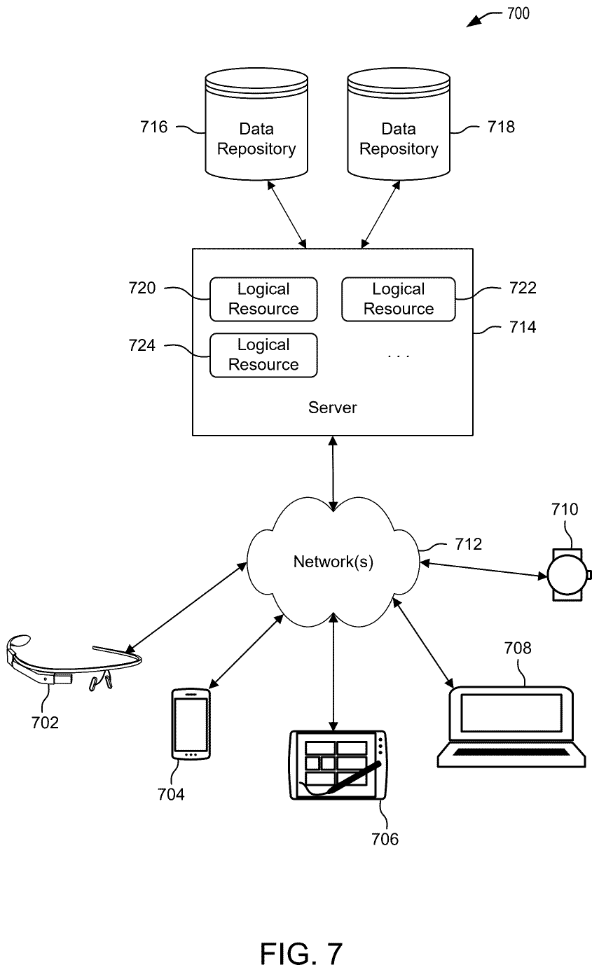

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for analyzing PR code changes while accounting for relevant code dependencies.

In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for analyzing PR code changes while accounting for relevant code dependencies in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for analyzing PR code changes while accounting for relevant code dependencies. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

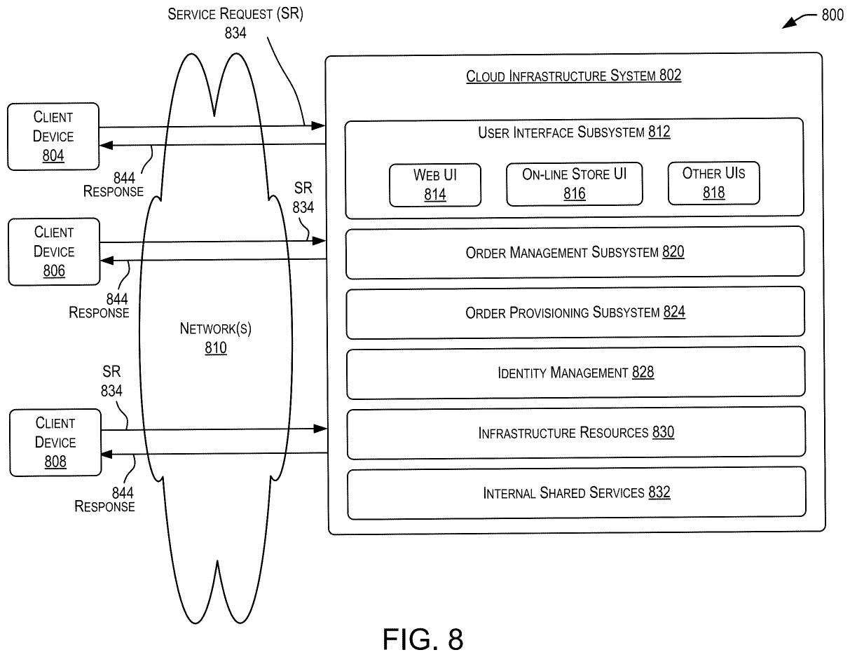

FIG. 8 is a simplified block diagram of a cloud-based system environment in which an example PR code analysis system analyzes PR code changes while accounting for relevant code dependencies, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 714. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g. utterances).

In certain aspects, such as the embodiment depicted in FIG. 8, cloud infrastructure system 802 may comprise a service management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the service provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant's information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

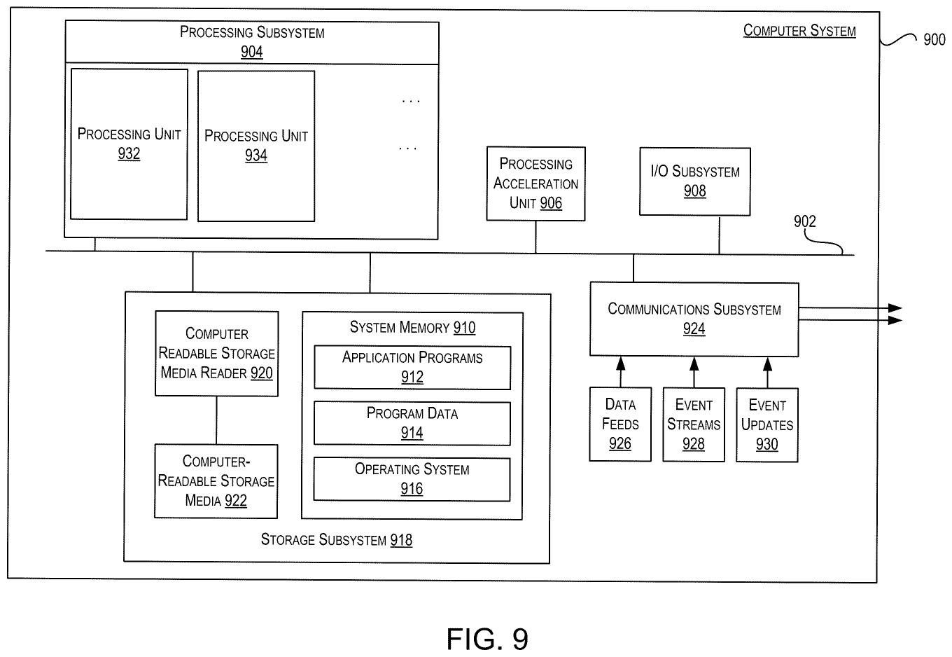

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory and/or transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

Byway of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
generating and storing a first call graph representing a plurality of dependencies between sets of code from a plurality of sources, wherein at least one of the plurality of dependencies is based at least in part on a call relationship between two sets of code;
tracking changes made to individual sets of code of a plurality of sets of code, wherein tracking the changes indicates that the changes are made to a subset of the plurality of sets of code; and wherein the subset of the plurality of sets of code is from a subset of sources of the plurality of sources;
based at least in part on the subset of the plurality of sets of code of the subset of sources of the plurality of sources indicated by tracking the changes, generating a second call graph representing a subset of the plurality of dependencies, wherein the subset of the plurality of dependencies comprise dependencies detected in the subset of the plurality of sets of code;
expanding the second call graph based at least in part on one or more dependencies in the first call graph, wherein the one or more dependencies are associated with at least one set of code of the subset of the plurality of sets of code, and wherein the one or more dependencies include at least one dependency that was not detected in the subset of the plurality of sets of code, wherein the at least one dependency involves a particular set of code from a particular source not in the subset of sources;
identifying one or more sets of code not in the subset of the plurality of sets of code based at least in part on the expanded call graph, wherein the one or more sets of code comprise the particular set of code; and
storing, in association with the tracked changes:
one or more references to the subset of the plurality of sets of code, and
one or more other references to the one or more sets of code not in the subset of the plurality of sets of code.

2. The computer-implemented method of claim 1, further comprising:
expanding the second call graph further based on one or more other dependencies in the first call graph, wherein the one or more other dependencies are associated with one or more other sets of code that are not in the subset of the plurality of sets of code and that are different than the one or more sets of code comprising the particular set of code.

3. The computer-implemented method of claim 1, further comprising:
accessing, in a user session, user input including a dependency order setting indicative of a requested code dependency analysis depth, wherein expanding the second call graph traverses the first call graph a number of steps away from the subset of the plurality of sets of code based at least in part on the dependency order setting.

4. The computer-implemented method of claim 3, further comprising:
expanding the second call graph to indicate second order dependencies of the subset of the plurality of sets of code based on the dependency order setting having a value greater than one; and
expanding the second call graph to indicate third order dependencies of the subset of the plurality of sets of code based on the dependency order setting having a value greater than two.

5. The computer-implemented method of claim 3, further comprising:
excluding, from the expanded call graph, dependencies of the one or more sets of code not in the subset of the plurality of sets of code based on the dependency order setting having a value of one.

6. The computer-implemented method of claim 1, wherein generating the second call graph comprises:
adding a node in the second call graph for each of the subset of the plurality of sets of code; and
adding an edge in the second call graph between each pair of nodes in the second call graph that correspond to a pair of sets of code having a dependency.

7. The computer-implemented method of claim 1, further comprising:
for each source of the plurality of sources, parsing code content of the source to identify one or more respective sets of code corresponding to a class definition, a function definition, a variable definition, or a function call;
generating the first call graph by:
adding, in the first call graph, a node for each identified set of code corresponding to the class definition, the function definition, the variable definition, or the function call; and
adding, in the first call graph, a directed edge for each identified function call, wherein the directed edge is from a first node that represents the function call to a second node that represents a function definition associated with the function call.

8. The computer-implemented method of claim 1, wherein the tracking the changes and the generating the second call graph are performed in parallel.

9. The computer-implemented method of claim 1, further comprising:
causing display, by a user interface, of information about the tracked changes based at least in part on the one or more references and the one or more other references.

10. The computer-implemented method of claim 9, wherein causing display of the information comprises causing display of a graphical element that is selectable to analyze a particular set of code that is accessible via a particular reference of the one or more other references.

11. A computer-program product comprising one or more non-transitory machine-readable storage media, including stored instructions configured to cause a computing system to perform a set of actions including:
generating and storing a first call graph representing a plurality of dependencies between sets of code from a plurality of sources, wherein at least one of the plurality of dependencies is based at least in part on a call relationship between two sets of code;
tracking changes made to individual sets of code of a plurality of sets of code, wherein tracking the changes indicates that the changes are made to a subset of the plurality of sets of code; and wherein the subset of the plurality of sets of code is from a subset of sources of the plurality of sources;
based at least in part on the subset of the plurality of sets of code of the subset of sources of the plurality of sources indicated by tracking the changes, generating a second call graph representing a subset of the plurality of dependencies, wherein the subset of the plurality of dependencies comprise dependencies detected in the subset of the plurality of sets of code;
expanding the second call graph based at least in part on one or more dependencies in the first call graph, wherein the one or more dependencies are associated with at least one set of code of the subset of the plurality of sets of code, and wherein the one or more dependencies include at least one dependency that was not detected in the subset of the plurality of sets of code, wherein the at least one dependency involves a particular set of code from a particular source not in the subset of sources;
identifying one or more sets of code not in the subset of the plurality of sets of code based at least in part on the expanded call graph, wherein the one or more sets of code comprise the particular set of code; and
storing, in association with the tracked changes:
one or more references to the subset of the plurality of sets of code, and
one or more other references to the one or more sets of code not in the subset of the plurality of sets of code.

12. The computer-program product of claim 11, wherein the set of actions further includes:
expanding the second call graph further based on one or more other dependencies in the first call graph, wherein the one or more other dependencies are associated with one or more other sets of code that are not in the subset of the plurality of sets of code and that are different than the one or more sets of code comprising the particular set of code.

13. The computer-program product of claim 11, wherein the set of actions further includes:
accessing, in a user session, user input including a dependency order setting indicative of a requested code dependency analysis depth, wherein expanding the second call graph traverses the first call graph a number of steps away from the subset of the plurality of sets of code based at least in part on the dependency order setting.

14. The computer-program product of claim 13, wherein the set of actions further includes:
expanding the second call graph to indicate second order dependencies of the subset of the plurality of sets of code based on the dependency order setting having a value greater than one; and
expanding the second call graph to indicate third order dependencies of the subset of the plurality of sets of code based on the dependency order setting having a value greater than two.

15. The computer-program product of claim 13, wherein the set of actions further includes:
excluding, from the expanded call graph, dependencies of the one or more sets of code not in the subset of the plurality of sets of code based on the dependency order setting having a value of one.

16. A system comprising:
one or more processors;
one or more non-transitory computer-readable media storing instructions, which, when executed by the system, cause the system to perform a set of actions including:
generating and storing a first call graph representing a plurality of dependencies between sets of code from a plurality of sources, wherein at least one of the plurality of dependencies is based at least in part on a call relationship between two sets of code;
tracking changes made to individual sets of code of a plurality of sets of code, wherein tracking the changes indicates that the changes are made to a subset of the plurality of sets of code; and wherein the subset of the plurality of sets of code is from a subset of sources of the plurality of sources;
based at least in part on the subset of the plurality of sets of code of the subset of sources of the plurality of sources indicated by tracking the changes, generating a second call graph representing a subset of the plurality of dependencies, wherein the subset of the plurality of dependencies comprise dependencies detected in the subset of the plurality of sets of code;
expanding the second call graph based at least in part on one or more dependencies in the first call graph, wherein the one or more dependencies are associated with at least one set of code of the subset of the plurality of sets of code, and wherein the one or more dependencies include at least one dependency that was not detected in the subset of the plurality of sets of code, wherein the at least one dependency involves a particular set of code from a particular source not in the subset of sources;
identifying one or more sets of code not in the subset of the plurality of sets of code based at least in part on the expanded call graph, wherein the one or more sets of code comprise the particular set of code; and
storing, in association with the tracked changes:
one or more references to the subset of the plurality of sets of code, and
one or more other references to the one or more sets of code not in the subset of the plurality of sets of code.

17. The system of claim 16, wherein the set of actions further includes:
for each source of the plurality of sources, parsing code content of the source to identify one or more respective sets of code corresponding to at least one of a class definition, a function definition, a variable definition, or a function call;
generating the first call graph by:
adding, in the first call graph, a node for each identified set of code corresponding to at least one of the class definition, the function definition, the variable definition, or the function call; and
adding, in the first call graph, a directed edge for each identified function call, wherein the directed edge is from a first node that represents the function call to a second node that represents a function definition associated with the function call.

18. The system of claim 16, wherein the tracking the changes and the generating the second call graph are performed in parallel.

19. The system of claim 16, wherein the set of actions further includes:
causing display, by a user interface, of information about the tracked changes based at least in part on the one or more references and the one or more other references.

20. The system of claim 19, wherein causing display of the information comprises causing display of a graphical element that is selectable to analyze a particular set of code that is accessible via a particular reference of the one or more other references.
